(19) United States
(12) Patent Application Publication
(10) Pub. No.: US 2026/0259368 A1
(43) Pub. Date: Sep. 3, 2026

(54) OPTICAL PROCESSING SYSTEM

(71) Applicant: ATONARP INC., Minato-ku, Tokyo (JP)

(72) Inventor: Prakash Sreedhar MURTHY, Minato-ku, Tokyo (JP)

(73) Assignee: ATONARP INC., Minato-ku, Tokyo (JP)

(21) Appl. No.: 18/867,202

(22) PCT Filed: May 19, 2023
(86) PCT No.: PCT/JP2023/018690

§ 371 Date: Nov. 19, 2024

(30) Foreign Application Priority Data
May 20, 2022 (JP) 2022-083343

(51) Int. Cl. G02B 6/12

(52) U.S. Cl. CPC G02B 6/12004; G02B 6/12019; G02B 2006/12038; G02B 2006/12121; G02B 2006/12135; G02B 2006/12138

(57) ABSTRACT

An optical processing system configures a first optical circuit by optically and interchangeably connecting a plurality of optical chips to, which are equipped with optical circuits for predetermined processes respectively, via a plurality of optical interfaces to. The optical circuit platform includes a plurality of identification interfaces to that acquire, from each of the plurality of optical chips, information relating to specifications of the plurality of optical chips that are connected to the plurality of optical interfaces, and the optical processing system further includes an output interface that reconfigures and outputs a processing result, which is obtained via the first optical circuit, based on information acquired via the plurality of identification interfaces.

### TECHNICAL FIELD

The present invention relates to an optical processing system.

### BACKGROUND ART

There are devices, called “optical chips”, “optical processing chips”, and “optical integrated elements”, on the market in which a circuit for performing predetermined processing on light (an optical signal), such as a planar lightwave circuit (PLC) that is made of a quartz-based material and includes an arrayed waveguide grating (AWG), has been integrated into a single chip.

International Patent Publication WO2003/034111 discloses an integrated optical circuit which includes an integrated arrayed wavelength grating (AWG) and has waveguides formed inside the integrated optical circuit. The first set of waveguides is a set of optical amplifiers that have been doped with rare earth ions. The second set of waveguides is a multiplexer or demultiplexer, such as an arrayed wavelength grating (AWG). The set of optical amplifiers and the AWG are coupled together via waveguides formed in the optical integrated circuit. The other elements of the optical integrated circuit are coupled or connected via optical fibers to the set of optical amplifiers and the AWG. The spectral response of the AWG is modified to compensate for the spectral gain of the AWG. The lengths of the individual optical amplifiers in the set of optical amplifiers may be varied to produce uniform power distribution across channels. The optical integrated circuit further includes a pump coupler for coupling a pump source to the set of optical amplifiers.

Japanese Laid-open Patent Publication No. 2019-159075 describes a small optical device that uses an optical integrated circuit (optical IC) which, by realizing skew adjustment and a reduction in optical loss, improves the output characteristics of an optical device. This optical device includes: an optical integrated circuit that includes a modulator unit and a receiver unit and transmits and receives optical signals on a plurality of channels; and a circuit board for transmitting electrical signals to and from the optical integrated circuit. In the first optical waveguide from the output of the modulator unit to an output port of the optical integrated circuit and in the second optical waveguide from an input port of the optical integrated circuit to an input of the receiver unit, the optical waveguides are disposed with the shortest length on each of a plurality of channels, the circuit board has a plurality of electric wires corresponding to the plurality of channels, and the length of each electric wire is set at a length that compensates for the difference in length of the optical waveguide between the channels.

Japanese Laid-open Patent Publication No. 2020-52269 describes the provision of an optical chip formed with an optical functional element with suppressed characteristic degradation and, by integrating such optical chip, an optical integrated circuit and an optical module that can be manufactured with a favorable yield. This optical chip is configured as an optical chip on which an optical functional element composed of an optical waveguide is formed. The optical chip is rectangular when viewed from above, with first and second sides that are parallel to each other, and third and fourth sides that are perpendicular to the first and second sides. The widths of the first and second sides are designed to have intrinsic dimensions that are set in advance. One or more input/output ports 50 are formed at one or both of a first end on the first side and a second end on the second side. The input/output ports are formed at intrinsic positions that are set in advance in keeping with the number of input/output ports with respect to the width of the first or second side.

Japanese Laid-open Patent Publication No. 2009-42469 describes the provision of an optical module in which optical wiring patterns and electrical wiring patterns can be easily created, a method of manufacturing such optical module, an optoelectronic composite circuit constructed using this optical module, and a method of manufacturing the same. This optical module is composed of a circuit board on which an electrical wiring pattern is formed, and a plurality of optical modules which are arranged and mounted in a state where their receiver parts and receiver part guides have been combined on the electric wiring pattern. Two adjacent ports formed on the contact surfaces of the two optical modules are optically coupled via an optical coupler part formed by applying and curing an optical coupling adhesive, electric wiring is formed by the electric wiring pattern of the circuit board and lower surface electrodes of the optical modules, and optical wiring is formed by the optical waveguides of the optical modules.

### SUMMARY OF INVENTION

A wide variety of devices that perform light-related processing are available. Devices with integrated circuits (optical integrated circuits, optical ICs, or optical chips), devices with integrated image sensors, and the like have also been provided. Optical modules that can form an optical integrated circuit by connecting a plurality of optical modules are also available. The functions provided by these devices can be assembled into and used as equipment such as a spectrometer. On the other hand, even for spectrometers, different optical circuits will be required when the specification, such as the input wavelength range and resolution, differs, resulting in a wide variety of spectrometers being provided. There is, therefore, demand for a system that can easily assemble and customize optical circuits that are suited to various uses according to the requirements of a user or an application.

One aspect of the present invention is an optical processing system (optical processing apparatus, optical processing device) including an optical circuit platform that is configured to configure a first optical circuit by optically and interchangeably connecting a plurality of optical chips (optical integrated elements, optical integrated devices) via a plurality of optical interfaces, wherein each of the plurality of optical chips includes an optical circuit for predetermined process. The optical circuit platform includes a plurality of identification interfaces that are configured to acquire, from each of the plurality of optical chips, information relating to specifications of the plurality of optical chips that are connected to the plurality of optical interfaces, and the optical processing system further includes an output interface that is configured to reconfigure and output a processing result, which is obtained via the first optical circuit, based on information acquired via the plurality of identification interfaces. This optical processing system includes a layer (first layer) that connects a plurality of optical chips to form (configure, construct) a circuit, and a layer (second layer) that acquires the specifications of such optical chips and defines the meaning of the optical circuit formed (configured, constructed) by the plurality of optical chips.

In this optical processing system, the optical circuit platform can easily select optical chips including optical circuits that are suited to various applications and can assemble and/or customize a first optical circuit suitably for a user or an application. In addition, by automatically acquiring information relating to the specifications of the plurality of optical chips that configure the first optical circuit via the identification interfaces that are coupled together with the optical interfaces and reconfiguring processing results obtained via the first optical circuit, it is possible to automatically output processing results that match the specifications of the optical chips that configure the first optical circuit. Information relating to the specifications of the optical chips may be obtained directly from the optical chips, or may be obtained indirectly from an internal or external (cloud) library via identification information obtained from the optical chips or the like. The specifications to be acquired may also include attributes (characteristic information) such as individual differences between individual optical chips. Accordingly, the present invention provides a plug-and-play type optical processing system that allows desired optical circuits to be easily assembled, customized, and reconfigured using optical chips.

One example of a plurality of optical chips that construct or configure the first optical circuit may include an AWG (arrayed-waveguide grating) chip, an input interface chip that inputs light to be separated or split by the AWG chip, and an image sensor chip that detects the light separated or split by the AWG chip, and may include a coupling interface chip that optically couples the AWG chip and the image sensor chip. This optical processing system can reconfigure information relating to a scattered image obtained by an image sensor chip (that is, the processing result of the first optical circuit) based on information including the wavelength band of light separated by the AWG chip and information including the resolution of the image sensor, and can output a spectrum of a predetermined wavelength band and a predetermined resolution as the processing result in combination with the image and intensity of a scattered image.

The optical circuit platform may include a connecting circuit (coupler circuit) for connecting or coupling the plurality of optical chips via the plurality of optical interfaces, and the optical processing system may further include a connecting control apparatus (connecting condition controller, optical circuit control platform) that is configured to reconfigure the connecting circuit based on the information acquired via the plurality of identification interfaces. The optical processing system may include an environmental condition measuring apparatus (environmental conditions measuring apparatus, environmental condition measuring sensor) that is configured to detect an operating environmental condition, including temperature, of the optical circuit platform and an operating environmental condition control apparatus that is configured to adjust the operating environmental condition(s), including the temperature, of the optical circuit platform to predetermined condition(s). The optical processing system may further include: an environmental condition(s) measuring apparatus that is configured to detect an operating environmental condition(s), including temperature, of the optical circuit platform; and a fluctuation suppressing control apparatus that is configured to reconfigure at least one of the processing result and the connecting circuit based on the measured operating environmental condition(s). The optical processing system may further include an optical circuit testing apparatus that is configured to input an optical signal that has been adjusted to check the characteristics of a first optical circuit configured on the optical circuit platform. The optical processing system may further include a self-tuning apparatus that is configured to reconfigure at least one of the processing result of the first optical circuit and the connecting circuit based on the self-check result of the optical circuit testing apparatus. The present invention also includes an optical processing system that includes a plurality of optical chips that configure the first optical circuit.

Another aspect of the present invention is a control method of an optical processing system including an optical circuit platform that configures a first optical circuit by optically and interchangeably connecting a plurality of optical chips, which are equipped with optical circuits for predetermined processes respectively, via a plurality of optical interfaces. The optical circuit platform includes a pluralitenvirony of identification interfaces that acquire, from each of the plurality of optical chips, information relating to specifications of the plurality of optical chips that are connected to the plurality of optical interfaces, and the control method includes reconfiguring and outputting a processing result, which is obtained via the first optical circuit, based on information acquired via the plurality of identification interfaces.

The optical circuit platform may include a connecting circuit for connecting the plurality of optical chips via the plurality of optical interfaces, and the control method may further include reconfiguring the connecting circuit based on information acquired via the plurality of identification interfaces. The optical processing system may include an environmental condition measuring sensor that detects an operating environmental condition(s), including temperature, of the optical circuit platform, and the method may further include adjusting the operating environmental condition(s), including the temperature, of the optical circuit platform to predetermined condition(s). The method may further include reconfiguring at least one of the processing result and the connecting circuit based on the measured operating environmental condition(s).

The method may further include inputting an optical signal that has been adjusted to check the characteristics of the first optical circuit and performing a self-check. The reconfiguring and outputting of the processing result in this method may further include reconfiguring the processing result based on a result of the self-check.

Such control methods may be provided as a program (program product) that controls the computer resources of an optical processing system either directly or by recording the program on an appropriate recording medium.

### BRIEF DESCRIPTION OF DRAWINGS

FIG. 1 is a block diagram depicting an example where a spectrometer is implemented as one example of an optical processing system according to the present invention.

FIG. 2 is a block diagram depicting another example of an optical processing system according to the present invention, where a different spectrometer is implemented.

FIG. 3 is a block diagram depicting an example configuration of a LIBS measuring apparatus.

FIG. 4 is a flowchart depicting one example of a control method of an optical processing system.

### DESCRIPTION OF EMBODIMENTS

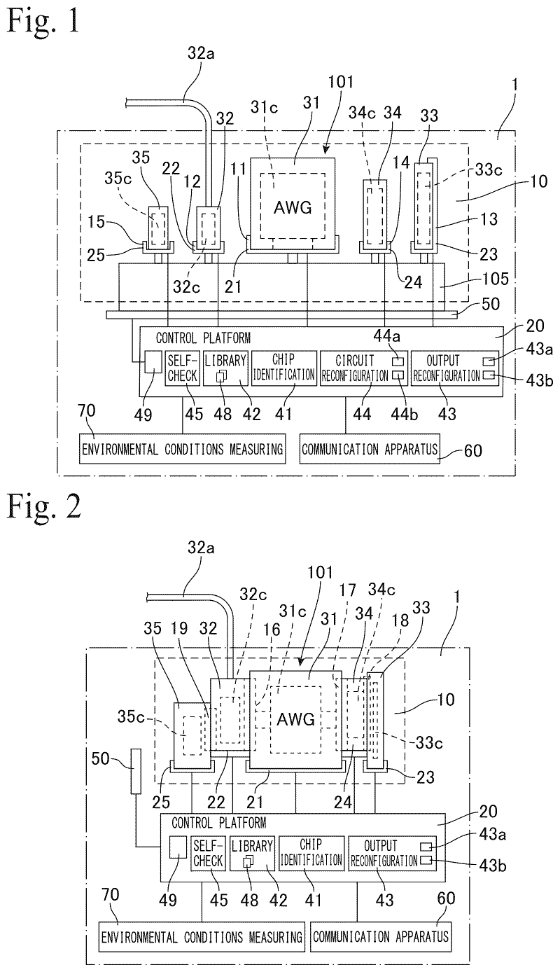

FIG. 1 depicts an example configuration of a customizable spectrometer (smart spectrometer, or system) 1, which is one example of an optical processing system and can easily provide a spectrometer of a suitable specification for an application. This optical processing system (system) 1 includes optical devices 31 to 35 in which optical circuit units 31c to 35c for predetermined processing have been integrated or provided as a single chip respectively. Examples of the single-chip devices (optical chips, optical integrated circuits, or optical ICs) 31 to 35 may include: an AWG chip 31 including an AWG (arrayed waveguide grating) 31c as an optical circuit part (unit); an interface chip 32 that is an input interface chip which inputs light to be separated or split by the AWG chip 31 and can integrate elements such as waveguides and elements such as optical amplifiers as the optical circuit part 32c; an image sensor chip 33 which includes, as the optical circuit part 33c, an image sensor that detects the light separated by the AWG chip 31; a connecting (coupling) interface chip 34 including functions as a waveguide and/or filter that optically connect the AWG chip 31 and the image sensor chip 33 as the optical circuit part 34c; and a self-check chip 35 including a laser module that generates light for testing (self-check) purposes as an optical circuit part (unit) 35c. The system 1 includes an optical circuit platform (first layer, optical integrated platform) 10 including optical interfaces 11 to 15 to which these optical chips 31 to 35 can be optically coupled (connected, interfaced) in a detachable manner.

The optical interfaces 11 to 15 may also respectively include functions as identification interfaces (information collecting interfaces, electronic interfaces) 21 to 25 that are configured to acquire, via optical signals or electric signals, characteristic information including the specifications of the respective optical chips 31 to 35, or identification information corresponding to such specifications. The optical circuit platform 10 may also include a connecting (coupler) circuit 105 for coupling or connecting the plurality of optical chips 31 to 35 via the plurality of optical interfaces 11 to 15. This connecting circuit 105 may have a function that enables the connecting method, order, branching, delay, and the like of some or all out of the plurality of optical interfaces 11 to 15 to be changed and/or reconfigured (that is, rearrangement or reconfiguration).

Although one example of the AWG chip 31 uses a planar lightwave circuit (PLC) made of a quartz-based material, the AWG chip 31 may alternatively use a semiconductor material. One example of the input interface 32 is an optical chip that has a function of receiving an optical signal via an optical fiber 32a, may include some or all of the circuit elements for connecting to an AWG, such as an input slab waveguide for connecting to the AWG chip 31, as the optical circuit part (optical circuit unit) 32c, and some or all of such circuit elements may be provided by the connecting circuit 105 of the optical circuit platform 10. The image sensor chip 33 may include an array including imaging elements (image elements) such as CCDs or CMOS as the optical circuit part 33c. The connecting interface chip 34 may include circuit elements for coupling or connecting to the AWG, such as an output side slab waveguide for connecting to the AWG chip 31 and the image sensor chip 33, as the optical circuit part 34c, and may include an autofocus function for controlling the resolution. Such function of the connecting interface chip 34 may be provided by the connecting circuit 105 of the optical circuit platform 10, and the connecting interface chip 34 itself may be omitted.

In the system 1, these optical chips 31 to 34 are detachably coupled via detachable optical interfaces 11 to 14 of the optical circuit platform 10 to form (construct, configure) an optical circuit (first optical circuit) 101 for achieving a desired function (in the present embodiment, a function as a spectrometer).

Examples of the laser module 35c mounted in the self-check chip 35 include a semiconductor laser module or a fiber laser module. The laser module 35c may output all of the wavelengths intended as input wavelengths of the optical circuit 101 to be configured as a spectrometer in the present system 1, or may provide some of such wavelengths or only light at the central wavelength. The self-check chip 35 functions as an optical circuit testing apparatus that inputs an optical signal that has been adjusted to check the characteristics of the first optical circuit 101 and then performs a self-check on the characteristics. Test light from the self-check chip 35 is provided via the input interface chip 32 or via the connecting circuit 105 of the platform 10 to the AWG chip 31 to periodically verify whether the expected output is being obtained from the optical circuit 101.

The optical processing system 1 further includes a control platform (second layer, optical circuit control platform, control apparatus, or digital processing apparatus) 20. An example of the control platform 20 is a digital processing apparatus that includes computer resources such as a CPU and memory, with predetermined functions being implemented by a program (program product) 49. The control platform 20 includes a chip identification function (chip identification apparatus, chip information acquisition function, or chip information acquisition apparatus) 41 that is configured to acquire characteristic information including specifications, or identification information of optical chips relating to such characteristic information, of each of the optical chips 31 to 35 coupled via the identification interfaces 21 to 25 to the optical circuit platform 10. The optical interfaces 11 to 15 used for connecting may also serve as the identification interfaces 21 to 25. Each optical chip 31 to 35 may have different optical interfaces that function as the identification interfaces 21 to 25 or may have digital interfaces (electronic interfaces).

The characteristic information of the respective chips 31 to 35 may be stored in the chips 31 to 35 respectively as optical signals or as digital information, and may be acquired by the identification interfaces 21 to 25. The chips 31 to 35 may hold only identification information, such as type numbers and serial numbers, and the chip identification function (chip identifier) 41 may acquire characteristic information 48 including the specifications of the chips 31 to 35 from the identification information via a library (database) 42 stored in advance. The chip identification function 41 may connect to the cloud (that is, the Internet) via a communication apparatus 60 and obtain, based on the identification information and from an external server, characteristic information including the specifications of the chips 31 to 35.

The system 1 further includes an operating environmental condition measuring apparatus (environmental conditions measuring sensor or third layer) 70 that detects the operating environmental condition or conditions of the optical circuit platform 10 including temperature, and an operating control apparatus (operating environmental condition control device, operating environmental conditions controller) 50 that is configured to control the operating environmental condition(s) of the optical circuit platform 10. One example of an operating environmental conditions control apparatus 50 is a heater and/or cooling apparatus (such as a piezoelectric element), which may be configured to keep the operating temperature of the optical circuit platform 10 constant at all times or may be configured to keep the temperature constant at a predetermined value that is higher than the expected ambient temperature. When the operating environmental conditions measuring apparatus 70 includes an acceleration sensor, an air pressure sensor, or the like, the operating environmental conditions control apparatus 50 may also include an anti-vibration function, a vibration isolation function, a pressure adjusting function, or the like.

The system 1 further includes a communication apparatus (communication layer) 60 that is configured to communicate with the external or periphery devices. The communication apparatus 60 includes a function of providing information generated by the control platform 20 to an external application. The communication apparatus 60 may also have a function of acquiring information for initializing the system 1 from an external application and transmitting such information to the control platform 20.

The control platform 20 includes an output interface 43 that is configured to reconfigure and output the processing results obtained via the first optical circuit (spectrometer) 101 configured in the optical circuit platform 10 based on information 48 acquired via the plurality of identification interfaces 21 to 25. The output interface 43 acquires the data acquired by the image sensor chip 33 via the optical interface 13 or the identification interface 23, reconfigures (processes or rearranges) the data under conditions that suit characteristic information including the specifications of the AWG chip 31 and the image sensor chip 33, and outputs the data via the communication apparatus 60 as the spectral data required by the application to which the system 1 is connected. As one example, the output interface 43 can reconfigure information relating to a scattered image obtained by the image sensor chip 33 (that is, the processing result of the first optical circuit 101) based on information including the wavelength band of the light separated by the AWG chip 31 and information including the resolution of the image sensor 33c and, by combining with an image and intensities of the scattered light, can output a spectrum with a predetermined resolution in a predetermined wavelength band as the processing result of the first optical circuit 101.

The output interface 43 may have a function as a fluctuation suppression control device 43a that is configured to reconfigure the processing result of the first optical circuit 101 based on the operating environmental conditions measured by the environmental conditions measuring apparatus 70. Fluctuations or varies at each chip due to varying or fluctuations in the environment, such as temperature, that cannot be covered by the operating environmental conditions control apparatus 50 may be corrected (compensated), or the processing results may be corrected (compensated) using software to reduce the power consumption of the operating environmental conditions control apparatus 50.

The control platform 20 may be equipped with a self-check apparatus (self-check function) 45 that is configured to perform a characteristics check of the first optical circuit 101 formed or configured in the optical circuit platform 10 using an optical circuit testing apparatus implemented by the self-check chip 35. In addition, the output interface 43 may have a function as a self-tuning apparatus 43b that is configured to reconfigure the processing results of the first optical circuit 101 based on the results of a self-check by an optical circuit testing apparatus realized by the self-check chip 35.

The control platform 20 may also include a function of a connecting control apparatus (connecting conditions controller, circuit reconfiguration apparatus) 44 that is configured to reconfigure the connecting circuit 105 of the optical circuit platform 10 based on the information 48 acquired via the plurality of identification interfaces 21 to 25. The circuit reconfiguration apparatus 44 may have a function as a fluctuation suppression control apparatus 44a that reconfigures the connecting circuit 105 based on the operating environmental conditions measured by the environmental conditions measuring apparatus 70. The circuit reconfiguration apparatus 44 may also have a function as a self-tuning apparatus 44b that reconfigures the connecting circuit 105 based on the self-check result of the optical circuit testing apparatus implemented by the self-check chip 35.

One example of the first optical circuit 101 implemented in the system 1 is a spectrometer. Spectrometers are used in a variety of applications. Examples of the system relating to a measuring apparatus or a monitoring apparatus include an OES (Optical Emission Spectrometer), a LIBS (Laser Induced Breakdown Spectroscopy), and CARS (coherent anti-Stokes Raman spectroscopy/scattering, which may be non-invasive, in vitro, or in vivo). These differ in either the measurement method, the object to be measured, or the measurement means, and even if the measurement method is the same, the wavelength range and/or the resolution to be analyzed may differ depending on the object to be measured. The control platform 20 can automatically configure, in the connecting circuit 105, a circuit that is suited to the specifications provided by the optical chips 31 to 34 connected to the optical circuit platform 10. In addition, a connecting circuit 105 that is provided in advance in the optical circuit platform 10 may be edited or reconfigured to conform or adjust to provided specifications based on the characteristic information 48 obtained via the identification interfaces 21 to 24 and to output to the application.

If a field in which the system 1 is to be applied is the same as its classification or type as an optical apparatus, that is, use as a spectrometer, the connecting circuit 105 provided in the optical circuit platform 10 can be kept the same. By replacing any of the optical chips 31 to 34 connected to the optical circuit platform 10, it may be possible to change to various specifications required as a spectrometer. By providing a plurality of reconfigurable or selectable circuits 105 in the optical circuit platform 10, the connecting circuit 105 may be reconfigured or selected according to an application or specification. Such control can be performed by the control platform 20.

The control platform 20 may include a function 43a for reconfiguring the processing result of a first optical circuit 101 configured in the optical circuit platform 10 according to or in keeping with an operating environmental condition(s) detected by the environmental conditions measuring apparatus 70. The characteristics or performance of the optical circuit units 31c to 34c mounted on the optical chips 31 to 34 may be temperature-dependent, and such dependency may vary depending on the optical chips that can be connected to the optical circuit platform 10. The control platform 20 can acquire the characteristics of each optical chip, which includes temperature dependency, directly or indirectly via the identification interfaces 21 to 24, which makes it possible to appropriately control the output of the optical circuit 101 configured in the system 1.

The control platform 20 may include an environmental conditions control function that is configured to control the operating environmental condition(s) of the optical circuit platform 10 via the environmental conditions control apparatus 50, such as a heater. The control platform 20 may have an optical test function (self-check function) 45 that is configured to input an optical signal that has been adjusted to check the characteristics of the optical circuit 101 configured in the optical circuit platform 10. As one example, test light may be adjusted using the laser module 35c of the self-check chip 35 and inputted under the same conditions as measurement light via the connecting circuit 105 of the optical circuit platform 10, and the results may be compared with the expected results. The output interface 43 of the control platform 20 can correct (fine-tune or reconfigure) the data obtained by the image sensor chip 33, thereby further improving the performance of the spectrometer implemented as the first optical circuit 101 and enabling more stable usage.

FIG. 2 is a block diagram depicting another example of the optical processing system 1. A different example of the system 1 in which a spectrometer is implemented (realized) as the first optical circuit 101 is depicted. The optical chips 31 to 35 connected to the optical circuit platform 10 may be chips including general-purpose optical interfaces 16 to 19 capable of optically connecting to adjacent chips respectively. A first optical circuit 101 including a predetermined optical circuit may be configured or constructed on the optical circuit platform 10 by connecting the optical chips 31 to 35 via these general-purpose interfaces 16 to 19. The optical circuit platform 10 includes identification interfaces (information interfaces) 21 to 25 for acquiring individual characteristic information of each of the optical chips 31 to 35. Accordingly, in the same way as described above, the control platform 20 can directly or indirectly acquire characteristic information including the specifications of the optical chips 31 to 35 that compose the first optical circuit 101. As a result, the output of the first optical circuit 101 (that is, the output of the image sensor chip 33) can be reconfigured based on the specifications of the optical chips and outputted as information that meets the requirements as a spectrometer.

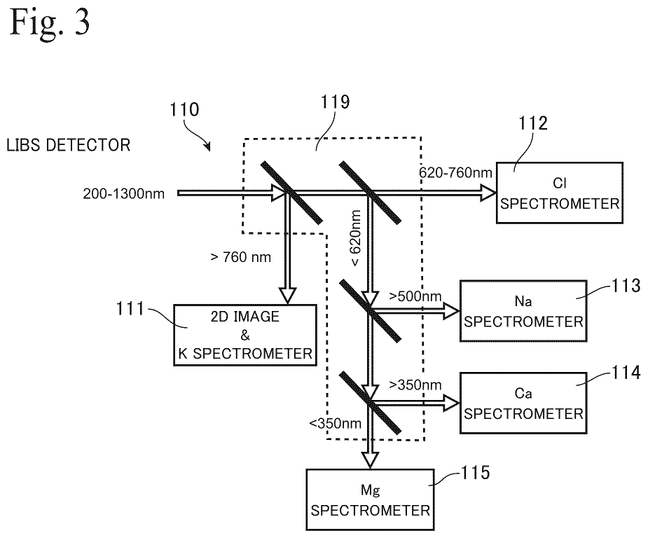

One example of a LIBS measuring apparatus is depicted in FIG. 3. The LIBS detector 110 is a detector type that prevents a drop in resolution when a wide range of wavelengths are measured with as a single spectrometer, and includes a dichroic mirror or filter 119 for measuring the wavelength band to be monitored by dividing it in advance. For this reason, the detector 110 requires spectrometers 111 to 115 that are compatible with a plurality of wavelength bands. As one example, the K spectrometer 111 detects wavelengths of 760 nm or longer, the CI spectrometer 112 detects wavelengths of 620 to 760 nm, the Na spectrometer 113 detects wavelengths of 500 to 620 nm, the Ca spectrometer 114 detects wavelengths of 350 to 500 nm, and the Mg spectrometer detects wavelengths of 350 nm or shorter.

With the optical processing system 1 according to the present embodiment, spectrometers 111 to 115 that match various specifications can be provided by configuring a first optical circuit 101 by attaching optical chips 31 to 34 that match the specifications to a common platform including the optical circuit platform 10 and the control platform 20. The optical circuit platform 10 may include a plurality of circuits corresponding to a plurality of specifications and an interface equipped with a plurality of chips that are suited to such circuits, a plurality of spectrometers may be configured on a single platform, and an optical processing system 1 capable of simultaneously configuring a plurality of optical circuits may be provided.

If the application is a measuring apparatus that uses CARS, one example of the specification required as a spectrometer is a wavelength of 780-920 nm (a bandwidth of 140 nm), a resolution of 0.07 nm, and an image depth of 2.5 mm. Other required spectrometer specifications include a wavelength band of 220 to 400 nm and a resolution of 0.5 nm, a wavelength band of 370 to 750 nm and a resolution of 0.8 nm, a wavelength band of 730 to 1080 nm and a resolution of 0.8 nm, a wavelength band of 225 to 1000 nm and a resolution of 1.5 nm, and a wavelength band of 480 to 1100 nm and a resolution of 1.5 nm. Spectrometers that meet these specifications can also be supported on a common platform by using the optical processing system 1 according to the present embodiment.

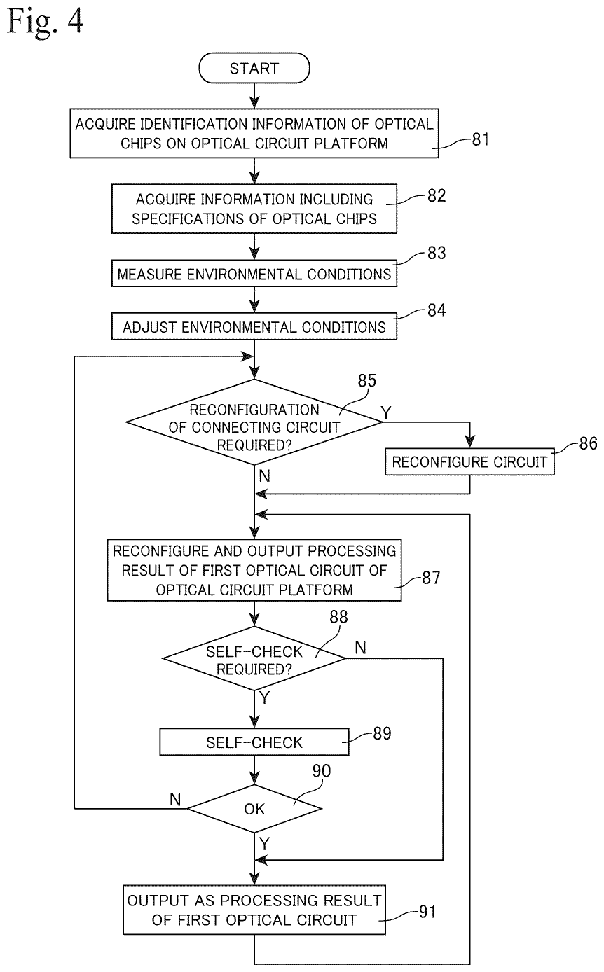

FIG. 4 is a flowchart depicting one example of a control method for the optical processing system 1. In step 81, the chip identification apparatus 41 of the control platform 20 acquires, via the identification interfaces 21 to 25, the identification information of each of the optical chips (light chips or optical ICs) 31-35 that are connected via the optical interfaces 11 to 15 to the optical circuit platform 10. In step 82, the chip identification apparatus 41 acquires characteristic information (attribute information) 48 including the specifications of the optical chips 31 to 35 from the library 42. If each optical chip 31 to 35 stores information including its specification, the chip identification apparatus 41 may acquire such information from each optical chip.

In step 83, the control platform 20 measures the operating environment (environmental conditions) of the optical circuit platform 10 or the periphery of the optical circuit platform 10 using the environmental conditions measuring apparatus 70, and in step 84, adjusts the operating environmental condition(s) using the operating environmental conditions control apparatus 50. In step 85, if the connecting control apparatus (circuit reconfiguration apparatus) 44 has determined that reconfiguration (rearrangement) of the connecting circuit 105 is necessary based on the information 48 on each chip acquired by the chip identification apparatus 41 and the environmental conditions measurement results, the circuit reconfiguration apparatus 44 reconfigures the connecting circuit 105 in step 86. As examples, it is possible to change the delay at a connecting circuit between chips, to convert and amplify an optical signal, and/or to change the standards of the connecting interfaces.

In step 87, the output interface 43 of the control platform 20 reconfigures and outputs the processing results of the first optical circuit 101 configured (constructed) on the control platform 20 based on the information 48 of each chip acquired by the chip identification apparatus 41 and the environmental conditions measurement results.

If the self-check apparatus 45 of the control platform 20 has determined in step 88 that a self-check of the first optical circuit 101 is required, in step 89 the self-check chip 35 is then used to test (self-check) the output of the first optical circuit 101. This self-check can be performed immediately after the first optical circuit 101 has been implemented on the optical circuit platform 10, or can be performed regularly or when the environmental conditions have changed. If the result of the self-check in step 90 is favorable, in step 91 the output interface 43 outputs the reconfigured result as the processing result (that is, the measurement result) of the first optical circuit 101 via the communication apparatus 60. If the self-check result does not satisfy predetermined requirements, the processing can return to step 85 and reconfigure the connecting circuit 105 or the like.

Although the optical processing system 1 has been described above using a spectrometer as an example, the present invention is not limited to a spectrometer and can also be applied to a system using a wide variety of optical integrated circuits and/or optical integrated elements used in optical communications, optical computing, and the like.

Disclosures in this specification includes the provision of a plug-and-play type optical processing system. The optical processing system (optical processing apparatus) 1 disclosed above includes a plurality of optical interfaces that optically and interchangeably connect at least one of a plurality of optical chips (optical integrated elements, optical integrated devices or light chips) equipped with optical circuits, and has a first layer (optical platform, optical integrated platform, or optical circuit platform) which, by mounting the plurality of optical chips, can perform optical processing specified by an application. The optical processing system may further include a second layer (optical circuit control platform) that acquires characteristic information or identification information of the optical chips associated with the characteristic information of the optical chips connected to the plurality of optical interfaces, reconfigures the first layer based on the characteristic information, and/or reconfigures the processing results on the first layer and supplies reconfigured results to the application.

The optical processing system may include a third layer that detects the operating environment (operating environmental conditions), including temperature, of the first layer and the second layer may include a function for reconfiguring the processing results on the first layer according to the operating environmental conditions detected by the third layer. Changes in the characteristics of each type of optical chip due to changes in the operating environmental conditions, such as temperature, or individual differences between individual optical chips may be recorded directly in each optical chip as characteristic information, or may be recorded via identification information in a database stored by or accessible to the second layer. The optical processing system may conversely have an environment control function for controlling the operating environmental conditions of the first layer so as to keep the operating environmental conditions constant.

The optical processing system may also have an optical test function that inputs an adjusted optical signal to check the characteristics of an optical circuit configured on the first layer. The second layer may include a function for configuring circuits that perform a plurality of different optical processes on the first layer.

One example of an optical processing system is a spectrometer, and the first layer may include, as optical chips, an AWG chip, an input interface that inputs light to be separated by the AWG chip, and an image sensor that detects the light that has been separated by the AWG chip, and also a connecting interface that optically couples or connects the AWG chip and the image sensor. The second layer may include a data processing function that acquires, via an optical interface or via a different interface, characteristic information or identification information of the optical chips related to such characteristic information of each optical chip connected to the first layer and outputs data acquired by an image sensor as spectral data. The optical processing system according to the present invention may include a plurality of optical chips mounted on the first layer.

The above description also discloses a control method of an optical processing system that has a first layer that includes a plurality of optical interfaces that optically and interchangeably connect at least one of a plurality of optical chips equipped with optical circuits, and that can perform, by mounting the plurality of optical chips, optical processing specified by an application. This method includes acquiring characteristic information or identification information of the optical chips associated with the characteristic information of optical chips connected to a plurality of optical interfaces, reconfiguring the first layer based on the characteristic information, and/or reconfiguring processing results of the first layer and supplying reconfigured processing results to an application.

The control method may include detecting an operating environmental condition(s) including temperature, of the first layer and reconfiguring processing results on the first layer according to the operating environmental condition(s). The control method may include controlling the operating environmental conditions of the first layer. The control method may include inputting an adjusted optical signal to check the characteristics of an optical circuit configured on the first layer. The control method may include configuring circuits that perform a plurality of different optical processes on the first layer. These control methods may be provided as a program (or program product) for controlling computer resources on the second layer, such program being provided either directly or having been recorded on an appropriate recording medium.

Note that although specific embodiments of the present invention have been described above, various other embodiments and modifications will be conceivable to those of skill in the art without departing from the scope and spirit of the invention. Such other embodiments and modifications are addressed by the scope of the patent claims given below, and the present invention is defined by the scope of these patent claims.

1. An optical processing system comprising an optical circuit platform that is configured to configure a first optical circuit by optically and interchangeably connecting a plurality of optical chips via a plurality of optical interfaces, each of the plurality of optical chips including an optical circuit for predetermined process,
wherein the optical circuit platform includes a chip identification apparatus that is configured to identify each of the plurality of optical chips by automatically acquiring, via a plurality of identification interfaces that are configured to acquire, from each of the plurality of optical chips, information relating to specifications of the plurality of optical chips that are connected to the plurality of optical interfaces, and
the optical processing system further comprises an output interface that is configured to reconfigure and output a processing result, which is obtained via the first optical circuit, based on information acquired via the plurality of identification interfaces.

2. The optical processing system according to claim 1,
wherein the optical circuit platform includes a connecting circuit for connecting the plurality of optical chips via the plurality of optical interfaces, and
the optical processing system further comprises a connecting control apparatus that is configured to reconfigure the connecting circuit based on the information acquired via the plurality of identification interfaces.

3. The optical processing system according to claim 1, further comprising:
an environmental condition measuring apparatus that is configured to detect an operating environmental condition, including temperature, of the optical circuit platform; and
an operating condition control apparatus that is configured to adjust the operating environmental condition, including the temperature, of the optical circuit platform to a predetermined condition.

4. The optical processing system according to claim 2, further comprising:
an environmental condition measuring apparatus that is configured to detect an operating environmental condition, including temperature, of the optical circuit platform; and
a fluctuation suppressing control apparatus that is configured to reconfigure at least one of the processing result and the connecting circuit based on the measured operating environmental condition.

5. The optical processing system according to claim 1,
further comprising an optical circuit testing apparatus that is configured to input an optical signal that has been adjusted to check characteristics of the first optical circuit.

6. The optical processing system according to claim 5,
further comprising a self-tuning apparatus that is configured to reconfigure the processing result of the first optical circuit based on a self-check result of the optical circuit testing apparatus.

7. The optical processing system according claim 1,
further comprising the plurality of optical chips that configure the first optical circuit.

8. The optical processing system according to claim 1,
wherein the plurality of optical chips that configure the first optical circuit include:
an AWG chip;
an input interface chip that is configured to input light to be separated by the AWG chip; and
an image sensor chip that is configured to detect the light separated by the AWG chip.

9. A control method of an optical processing system including an optical circuit platform that configures a first optical circuit by optically and interchangeably connecting a plurality of optical chips, which are equipped with optical circuits for predetermined processes respectively, via a plurality of optical interfaces,
wherein the optical circuit platform includes a chip identification apparatus for acquiring, via a plurality of identification interfaces that acquire, from each of the plurality of optical chips, information relating to specifications of each of the plurality of optical chips that are connected to the plurality of optical interfaces, and
the control method comprises automatically acquiring, by the chip identification apparatus, information relating to the specifications of each of the plurality of optical chips from each of the plurality of optical chips via the plurality of identification interfaces; and
reconfiguring and outputting a processing result, which is obtained via the first optical circuit, based on information acquired via the plurality of identification interfaces.

10. The control method according to claim 9,
wherein the optical circuit platform includes a connecting circuit for connecting the plurality of optical chips via the plurality of optical interfaces, and
the control method further comprises reconfiguring the connecting circuit based on information acquired via the plurality of identification interfaces.

11. The method according to claim 9,
wherein the optical processing system includes an environmental condition measuring apparatus that detects an operating environmental condition, including temperature, of the optical circuit platform, and
the control method further comprises adjusting the operating environmental condition, including the temperature, of the optical circuit platform to predetermined condition.

12. The method according to claim 9,
wherein the optical processing system includes an environment measuring apparatus that detects an operating environmental condition, including temperature, of the optical circuit platform; and
the control method further comprises reconfiguring at least one of the processing result and the connecting circuit based on the measured operating environmental condition.

13. The method according to claim 9,
further comprising inputting an optical signal that has been adjusted to check characteristics of the first optical circuit and performing a self-check.

14. The method according to claim 13,
wherein reconfiguring and outputting the processing result further includes reconfiguring the processing result based on a result of the self-check.

15. A program for controlling an optical processing system including an optical circuit platform that configures a first optical circuit by optically and interchangeably connecting a plurality of optical chips, which are equipped with optical circuits for predetermined processes, via a plurality of optical interfaces,
wherein the optical circuit platform includes a plurality of identification interfaces that acquire, from each of the plurality of optical chips, information relating to specifications of the plurality of optical chips that are connected to the plurality of optical interfaces, and
the program comprises an instruction that reconfigures and outputs a processing result, which is obtained via the first optical circuit, based on information acquired via the plurality of identification interfaces.
